(19) United States
(12) Patent Application Publication
(10) Pub. No.: US 2008/0028539 A1
(43) Pub. Date: Feb. 7, 2008

(54) Method of Preventing or Minimizing Dye Redeposition by Use of Polyesters

(76) Inventor: Herbert Koch, Raesfeld (DE)

Correspondence Address: C James Bushman;Browning Bushman, Suite 1800, 5718 Westheimer Suite 1800, Houston, TX, 77057-5771, US

(21) Appl. No.: 10/582,306

(22) PCT Filed: Dec. 10, 2004
(86) PCT No.: PCT/DE04/02716

§ 371 Date: Aug. 10, 2007

(30) Foreign Application Priority Data
Dec. 10, 2003 (DE) 103 58 097.2

(51) Int. Cl. C11D 3/37; D06P 5/08

(52) U.S. Cl. 8/115.6; 8/116.1

(57) ABSTRACT

The invention relates to a method for preventing or minimizing color deposits on textile fabric during a decolorization process, particularly during a stonewash process. Preferably, the fabric in question is indigo-dyed cotton fabric or fabric containing cotton. The anti-color-deposit agent is a polyester, preferably a terephthalic acid-polyester-polyether-polymer.

The present invention relates to a method of preventing or minimizing dye redeposition onto textile fabrics during a dye-removing process, particularly stonewashing. The fabric is typically an indigo-dyed cotton cloth or cotton-containing fabric. The backstaining inhibitor used herein is a polyester, preferably a terephthalic acid-polyester-polyether polymer.

The typically faded or worn look of indigo-dyed denim fabric is created by treating the fabric by the so-called ‘stonewashing method’.

Towards the end of the seventies, pumice stone had become a favorite means to accelerate the aging of indigo-dyed fabric. A stonewashed look can be produced because the dye mainly deposits onto the fiber surface. Fiber-skin dyeing is typical of the indigo-dyeing method, wherein the dye deposits onto the fiber skin without thoroughly coloring the thread.

When treating indigo-dyed fabric in a washing machine, the fiber skin is partially abraded by pumice stones until the undyed inner thread appears (see Textilvered-lung; journal 34 (11-12), pp. 26-31 (1999); 35 (1-2), pp. 23-27 (2000), 35 (3-4), pp. 27-30 (2000); ‘Jeans—das blaue Phänomen’ (Jeans—The Blue Phenomenon)).

Normally, the quantity of pumice stones utilized for fabric aging varies from once to twice the fabric weight, depending on the desired appearance.

The conventional stonewashing method has several economic and environmental disadvantages. Both denim fabric and washing machine, e.g. the cylinder sheets, are exposed to considerable mechanical wear.

The pumice stones produce grit, which needs to be removed from the fabric by repeated washing, which in turn increases the amount of waste water. In addition, pumice stones produce large amounts of sludge comprising fiber residues and indigo pigment.

Since the eighties a new method utilizing special enzymes has become widespread. Superficial abrasion of cellulose is now caused by enzymes instead of pumice stones. A customary enzyme used for this purpose is cellulase, which is temporarily linked to the cellulose by an anchor, thereby splitting the cellulose at its 1,4-beta-glucosidic bond and partially loosening the indigo-dyed cotton fiber surface, whereby the inner, undyed, white parts of the cotton fiber appear. The cellulases thus produce the same optical effect as pumice stones.

The cellulases employed in the enzymatic stonewashing method can be divided into two groups, namely acidic and neutral cellulases. The terms ‘acidic’ and ‘neutral’ refer to the optimum pH values for the greatest enzyme activity. For acidic cellulases the pH range should be from about 4 to 6, whereas neutral cellulases have proved to be most active at pH values from about 6 to 8. Acidic cellulases are more abrasive than neutral ones, i.e. the same effect is produced with only 10 to 20% of the amount of neutral cellulase, so that the treatment time is reduced and cost are saved due to their significantly lower price. However, these cellulases, too, cannot prevent backstaining (dye redeposition).

By the term ‘dye redeposition’ is meant backstaining of the cotton threads with released dye or coloration of undyed fabric. The dye may redeposit at various spots, e.g. inside pockets, labels, seams, zippers, and especially the inside/outside surfaces of denim. Such backstaining causes poor contrast of color, which is undesirable.

The problem of dye redeposition onto stonewashed fabric is much more distinct than on customary household linens due to the considerably higher dye concentration during the washing step.

According to the technical literature on this subject, several theories have been put forward to explain this occurrence. One hypothesis says that cellulose is enzymatically decomposed into glucose units, which are capable of partially reducing indigo in solution and on the fiber as well. The reduced variant has a lower affinity for cellulose fibers, thereby causing increased deposition on the inside lining of pockets. Another explanation has been offered according to which indigo has a strong affinity for cellulase, which is bound through the cellulose binding domain (CBD) to the cellulose fiber.

It can be presumed that dye redeposition is connected with the cellulase blend, dye, type and concentration of surfactant, and the PH value chosen.

The problems associated with dye redeposition are known in the art and several methods of reducing backstaining have been described.

WO 01/92453 discloses an enzymatic method of minimizing dye redeposition by adding lipolytic enzymes, preferably cutinase. WO 94/29426 provides an acidic cellulase for this purpose, which is used in combination with a special protease. DE 19606619 discloses acidic cellulases in combination with fatty alcohol polyglycol ethers and inorganic and/or organic buffer salts.

Furthermore, the use of nonionic fatty alcohol ethoxylates in combination with anionic alkane sulfonate to produce an anti-redeposition effect has been described. However, anionic surfactants in particular produce an adverse interaction with the cellulase, thereby reducing its abrasiveness.

WO 01/57173 provides an enzymatic two-component system used to create a good stonewashed effect on dyed cotton or cotton-containing fabrics, accompanied by very little backstaining. Said two-component system contains special aqueous polymer dispersions in addition to a cellulase component. The solid particles are styrene(meth)acrylate copolymers grafted onto starch as a graft basis.

WO 95/35363 discloses a method of creating a stonewashed appearance by utilizing acidic cellulases in the presence of dye redeposition inhibitors selected from the group consisting of natural and synthetic inorganic silicates, polyalkylene oxides, acrylic acid-polymers, and natural and (semi)synthetic polysaccharides.

A large number of prior-art dye transfer inhibitors, such as polyvinyl pyrrolidone, polyvinyl pyridine-N-oxide, etc. are efficient agents for reducing the redeposition of direct dyes onto cotton. Nevertheless, they cannot prevent backstaining of indigo in particular, which may be due to the extreme hydrophobicity of this dye.

According to WO 99/67350, polyesters can be produced by reacting polymeric waste terephthalates, such as polyethylene terephthalate, polybutylene terephthalate, or poly(cyclohexanedimethanol)terephthalate, glycols, and oxalkylated polyols with at least 3 hydroxy groups. Said polyesters are utilized in dyeing/dye removal processes to prevent backstaining. The polyesters actually disclosed in said patent are still produced by means of trimellitic acid and/or isophthalic acid or the derivatives thereof.

It is the object of the present invention, to provide an efficient agent preventing redeposition of dye onto textile fabrics during a dye-removal process, especially during stonewashing.

This agent is required to act as a redeposition inhibitor for released dye, especially indigo, on denim fabric and typical accessories of denim garments, such as pocket inside linings, seams, labels, and zippers of jeans, which often are not made of cotton.

According to the present invention, this object is achieved by a method of preventing or minimizing dye redeposition onto textile fabrics by contacting the dyed fabric comprising cotton fibers with a dye redeposition inhibitor during the dye removal process, characterized in that the dye redeposition inhibitor is a polyester, which can be produced by reaction, preferably esterification, of at least the following monomers:

(A) one or more dicarboxylic acid compound(s),

(B) one or more diol compound(s) having from 2 to 6 carbon atoms, and

(C) polyetherols with one or two hydroxy groups having at least 6 oxygen atoms, wherein the monomers (A), (B), and (C) come to more than 80 wt. % of the incorporated monomers, preferably more than 90 wt. %, especially more than 95 wt. %.

Preferred embodiments of the subject invention are set out in the subordinate claims or will be apparent from the ensuing description.

Use of the redeposition inhibitors described in the method of the invention results in very little backstaining, accompanied by an excellent stonewashed look.

According to the present invention, the object is achieved by utilizing polymers known as soil release polymers, which are preferably amphiphilic, polyester-containing polyether monomer sequences, more preferably nonionic ones.

The polyether monomer sequences are produced from polyetherols. The term ‘polyetherols’ as used herein refers to compounds with one or two hydroxy groups having at least 6 oxygen atoms, preferably at least 10 oxygen atoms, more preferably more than 16 oxygen atoms.

By the term ‘diols’ as used herein is meant compounds having two hydroxy groups and not more than one ether group, preferably none.

According to an embodiment of the present invention, it is preferable to use liquid polyesters, which are free-flowing at room temperature and hence especially appropriate for incorporation into liquid stonewashing formulations. Said polyesters can be produced by reaction, preferably polycondensation, of

(A) 20 to 50 mole % of one or more dicarboxylic acid compound(s),

(B) more than 0 to 30 mole % of one or more diol compound(s) having from 2 to 6 carbon atoms,

(C) 10.1 to 29.9 mole % of one or more polyol compound(s) having at least 3 OH groups, and

(D) 10.1 to 50 mole % of one or more water-dilutable polyetherol(s), which can be produced by the addition of one or more C₂- to C₄-alkylene oxide(s) to a C₁ to C₁₈ alcohol, especially a C₁ to C₆ alcohol, with one hydroxy group, wherein the alkylene oxide/alcohol mole ratio is in the range from 4 to 100:1.

The compounds described hereinabove and their preferred variants have been disclosed in WO 02/18474-A1 which, with regard to the definition of said compounds, is completely incorporated herein by reference.

The statements related to mole % made hereinabove are to be understood as final and independent of one another and refer to the total of the components (A) to (D). The polyester was made utilizing essentially no additional component, i.e. <5 mole % of additional component(s), preferably <1 mole %. As used herein, the term ‘room temperature’ means a temperature from 15° C. to 25° C., especially 20° C.

According to the main claim of the present invention, the term ‘compounds’ employed herein is defined as organic compounds, which usually do not contain any other atoms besides carbon, hydrogen, and oxygen after the reaction, i.e. incorporation into the polymer. For example, after incorporation into the polyester, the dicarboxylic acid compounds may have carboxyl groups besides carbonyl groups or hydroxy groups, but do not have sulfonyl- or halogen groups for instance.

The dicarboxylic acid compound (A) includes aliphatic and/or aromatic dicarboxylic acids and their derivatives, e.g. their monoesters, diesters, anhydrides, or mixtures. The dicarboxylic acid compounds preferably have 3 to 40 carbon atoms, related to the dicarboxylic acid or the dicarboxylic acid group. According to the present invention, the aromatic dicarboxylic acid compounds may especially be terephthalic acid, isophthalic acid, phthalic acid, their mono- and dialkyl esters having C₁- to C₅-alcohols, e.g. dimethyl terephthalate, and mixtures of said compounds. Examples of aliphatic dicarboxylic acid compounds include malonic, succinic, fumaric, maleic, glutaric, adipic, pimelic, suberic, azelaic, and sebacic acid dialkyl esters. It is particularly preferable to use isophthalic acid and phthalic acid, especially terephthalic acid and the dimethyl-, diethyl-, dipropyl-, and dibutyl esters thereof.

According to the method of the invention, the dicarboxylic acid of choice is terephthalic acid, which is preferably used in quantities of greater 90 mole %, preferably greater 95 mole %, based on the amount of di- or tricarboxylic acid compounds used in the formulation. In addition, other dicarboxylic acid compounds can be employed as well.

The aromatic dicarboxylic acids include terephthalic acid and especially isophthalic acid, phthalic acid, their mono- and dialkyl esters having C₁ to C₅ alcohols, e.g. dimethyl terephthalate, and mixtures of said components. Examples of aliphatic dicarboxylic acid equivalents include malonic, succinic, fumaric, maleic, glutaric, adipic, pimelic, suberic, azelaic, and sebacic acid dialkyl esters.

It is particularly preferable to use terephthalic acid and phthalic acid and the dimethyl-, diethyl-, dipropyl-, and dibutyl esters thereof.

Tricarboxylic acid compounds resulting in heavily branched polymer structures may be employed as well. For example, trimellitic acid or its derivatives, such as anhydrides and esters, are suitable for this purpose, but actually the latter ones cannot be recommended.

The polyol compounds (D) preferably have 3 to 12 carbon atoms. Examples of polyol compounds having at least 3 OH groups include pentaerythritol, trimethylol ethane, trimethylol propane, 1,2,3-hexanetriol, sorbite, mannite, mono-, di-, and triglycerol, 1,2,3-butanetriol, 1,2,4-butanetriol. It is preferable that glycerol be used.

Examples of the polyetherols (C) include products obtained by the addition of ethylene oxide, propylene oxide, butylene oxide, or mixtures thereof to water or aliphatic C₁ to C₁₈ alcohols, preferably C₁ to C₆ alcohols, such as methanol, ethanol, propanol, or butanol. It is preferable to use addition products of ethylene oxide to methanol or water.

Polyetherols are a very important constituent of the aforesaid polymers, wherein they preferably come to more than 30 wt. %. Examples include polyethylene glycol, polypropylene glycol, polybutylene glycol, and addition products of ethylene oxide, propylene oxide, butylene oxide, or their mixtures to aliphatic alcohols, such as methanol, ethanol, propanol, butanol, or long-chain fatty alcohols. It is preferable to use polyethylene glycols with mean molecular weights from 500 to 10,000 g/mole and polyethylene glycol monomethyl ethers with molecular weights from 2,000 to 5,000 g/mole.

According to the present invention, the diol compound (B) may be for example ethylene glycol, 1,2- or 1,3-propylene glycol, neopentyl glycol, 1,2-butylene glycol, 3-methoxy-1,2-propylene glycol, and the dimers and trimers thereof. The diol compound (B) preferably has 2 to 6 carbon atoms. Mixtures of various diols are appropriate as well. It is preferable to use ethylene glycol and/or propylene glycol.

In principle, the polymers can anionically be modified as well, i.e. for example by introcondensation of anionic monomers, such as sulfophthaloyl-, sulfoisophthal-oyl, and sulfoterephthaloyl groups utilized for instance in the form of their salts, especially alkali- or ammonium salts. In general, aliphatic anionic monomers, which are derived from sulfonated aliphatic diesters, such as maleic acid, adipic acid, sebacic acid etc., may be utilized for this purpose.

The polyesters employed according to the method of the invention may also be capped with a terminal group. Appropriate terminal groups include:

a) sulfoaroyl groups,

b) groups of the formula MO₃—S—(O)ᵤ—(CH₂)ₚ—(RO)_{w}—,

wherein M represents a metal atom, R means ethylene or mixtures of ethylene and propylene, u is 0 or 1, p is 0 or 1, and w represents a number from 1 to 100,

c) poly(oxyethylene)monoalkyl ether groups, wherein the alkyl group has from 1 to 24 carbon atoms and the polyoxyethylene group is comprised of 2 to 200 oxyethylene units,

d) acyl- and aroyl groups having from 4 to 40 carbon atoms,

e) hydroxyacyl- and hydroxyaroyl groups having from 2 to 25 carbon atoms,

f) poly(oxyalkylene)monoalkyl phenol ether, wherein the alkyl group has from 6 to 18 carbon atoms and the polyoxyalkylene group is comprised of 0 to 80 oxyalkylene units

and mixtures thereof.

Nonionic PET-(polyethylene terephthalate)-POET (polyoxyethylene terephthalate)polyesters are particularly preferred. Said polyesters can be produced by polycondensation of terephthalic acid or terephthalates with monoethylene glycol and polyethylene glycol. It is preferable to use polyethylene glycols having molecular weights from 2,000 to 10,000 g/mole. It is also preferable that the resultant PET-POET copolymers be solid at room temperature and have mean molecular weights from 5,000 to 40,000 g/mole.

In addition, polyester-polyether copolymers, which are liquid at room temperature, are preferably employed. Said copolymers may be composed according to the formula

X—(OCH₂—CH₂)ₙ—[—(OOC—R¹—COO—R²)ᵤ—]—OOC—R¹—COO—(CH₂—CH₂O)ₙ—X,

wherein each R¹ residue is a 1,4-phenylene residue, optionally substituted for mono- or di-C₁-C₃-alkyl; the R² residues are principally ethylene residues, 1,2-propylene residues, or mixtures thereof; each X represents independently of one another hydrogen, a C₁ to C₁₂ hydrocarbon residue, especially ethyl or methyl; each n is independently of one another a number from 7 to 115, and u is a number from 3 to 10.

According to another embodiment, average polyesters composed according to the following empirical formula

(CAP)ₓ(T)_{z}(I)_{q}(D)ᵣ(P)ₛ(En)ₜ(A)_{y}(EG/PG)ᵥ

are used, wherein

(CAP) represents terminal groups capping the polymer at its end and
a) sulfoaroyl groups,
b) groups of the formula MO₃—S—(O)ᵤ—(CH₂)ₚ—(RO)_{w}—,

wherein M represents a metal ion, ammonium ion, or substituted ammonium ion, R means ethylene or mixtures of ethylene and propylene, u is 0 or 1, p is 0 or 1, and w represents a number from 1 to 100,
c) poly(oxyethylene)monoalkyl ether groups, wherein the alkyl group has from 1 to 24 carbon atoms and the polyoxyethylene group is comprised of 2 to 200 oxyethylene units,
d) acyl- and aroyl groups having from 4 to 40 carbon atoms,
e) hydroxyacyl- and hydroxyaroyl groups having from 2 to 25 carbon atoms,
f) poly(oxyalkylene)monoalkyl phenol ether, wherein the alkyl group has from 6 to 18 carbon atoms and the polyoxyalkylene group is comprised of 0 to 80 oxyalkylene units
g) and mixtures thereof, and x represents a number from 0 to 2,

(T) is an arylene dicarbonyl group and z represents a number from 1 to 50,

(I) is an internal anionic group and q represents a number from 0 to 30,

(D) is an acetal group and r represents a number from greater 0 to 80,

(P) means polyol groups having at least 3 —OH groups, s is a number from 0 to 80, wherein the polyol quantity is less than 30 mole %, related to the total monomer units,

(En) is a poly(oxyalkylene)oxy group composed of 2 to 100 oxyalkylene groups, wherein t is a number from 0 to 25, preferably from greater 0 to 25, and the alkylene groups have from 2 to 6 carbon atoms,

(A) is a 1,n-alkylene dicarbonyl group composed of 2 to 24-carbon atoms, and y represents a number from 0 to 15,

(EG/PG) is an oxyethylene oxy- or oxypropylene oxy group or mixtures thereof, and v represents a number from 0 to 80, and

wherein the polyesters have molecular weights from 500 to 100,000 g/mole, preferably from 1,000 to 20,000 g/mole.

The polyesters defined hereinabove are subject matter of patent WO 99/09125 which, with regard to the divergent definition of the polyesters termed therein ‘amphiphilic polymers’, is completely incorporated herein by reference.

The synthesis of the polymers employed according to the present invention may be carried out as a direct reaction of all the monomer units in a single step yielding random polymers. According to another method, the synthesis may also be carried out in several steps, e.g. including precondensation of various building monomers.

Normally, the temperature is in the range from about 80° C. to 350° C. and the pressure range is from normal to <1 mbar. It is preferable to carry out the condensation at temperatures ranging from 150° C. to 280° C. in the presence of customary polycondensation—and transesterification catalysts. The molecular weights of the resultant polymers may be adjusted as required, preferably between 1,000 and 40,000 g/mole.

Appropriate catalysts are known from the technical literature. When using free dicarboxylic acids or anhydrides as components, p-toluene sulfonic acid is a preferable catalyst. When using dicarboxylic acid dialkyl ester, customary transesterification catalysts are suitable, e.g. mixtures of calcium acetate and antimony oxide, organic and inorganic tin- and zinc compounds (e.g. stannanes, zinc acetate, or the TEGO™ catalysts of Degussa), or tetraalkoxy titanates, such as titanium tetraisobutanolate or titanium tetraisopropanolate.

The condensation may be carried out in the presence of antioxidants, such as substituted phenols, e.g. 2,5-ditertiary butyl phenol, 2-methylcyclohexyl-4,6-dimethyl phenol, phosphorous acid, or other customary antioxidants for this purpose. Said compounds prevent discoloration of the polyesters due to oxidation during condensation.

Unsatisfactorily stained polyesters of the invention can be aftertreated, e.g. by bleaching with hydrogen peroxide resulting in a significantly lighter color.

The polymers employed according to the method of the invention may be solid or pasty or liquid. There are several methods of polymer incorporation into a formulation. For powdery (i.e. solid) stonewashing formulations it is preferable that the additives be solid, too. According to the morphology, the polymers can be incorporated as a 100-percent product, which may be ground for instance, or as a supported product applied to a solid carrier by any of the granulating methods known in the art.

In principle, said compounds can also be employed in the form of a matrix. By the term ‘matrix’ as used herein is meant a blend of amphiphilic polyester-polyether copolymers and nonionic surfactants, for instance, such as alcohol ethoxylates, alcohol propoxylates, mixed alcohol alkoxylates, alkyl polyglucosides, glucose amides, polyethylene glycols, polypropylene glycols, mixed polyalkylene glycols, solvents, e.g. isopropanol, propylene glycol, glycol ether, water etc.

By blending or compounding said polymers with other products it is possible for example to create products having further improved flow properties and lower viscosities.

The polyester-polyether copolymers may also be applied to carriers such as zeolites, phosphates, citrates, sodium sulfate, pumice stones or pumice equivalents, e.g. perlites etc., and then can be converted into free-flowing, powdery compounds, which are useful when incorporated in powdery stonewashing formulations.

It is preferable to use the redeposition inhibitors according to the method of the invention in amounts from 0.1 to 20 wt. %, based on the stonewashing formulation (abrasives not included).

In principle, the dye redeposition inhibitors can be incorporated into the formulation, but they may also be incorporated later directly into the stonewashing liquor.

Most of the formulations are based on a combination of mechanical treatment and enzyme treatment (stonewashing and biostoning). The pumice stones utilised for such treatment are frequently replaced by sintered perlites, which are less abrasive due to their hardness. Furthermore, they are smaller than pumice stones and have a larger surface, so that the stones can be rinsed off with the laundry liquor.

The pivotal component of enzymatic formulations for producing a stonewashed look is one or several cellulase(s). Two groups of cellulases are usually employed, namely acidic and neutral ones.

Said formulations include further components besides the dye redeposition inhibitors of the invention.

For example, they contain a buffer system, which maintains the pH value steady within certain limits in order to ensure optimum performance of the enzymatic system. Buffering of the cellulase bath is most important because especially the fabric frequently causes alkalinity.

Surfactants are another essential component of said formulations. Surfactants have the function among others to enable rapid wetting of the cellulose fiber so that the cellulase is capable attacking the fiber as quickly as possible. Furthermore, they are employed for removing excess size, suspending indigo dye, and emulsifying oily and fatty components besides their functions as dispersants and running-crease inhibitors.

Preferably, the nonionic surfactants described in the art, e.g. fatty alcohol alkoxylates, castor oil ethoxylates etc., are utilised for this purpose. Nonionic surfactants are preferable because they are capable of wetting the fibers pretty well without much affecting the cellulase activity. Anionic surfactants may have negative effects on the enzymes, e.g. reduced activity or incompatibilities. The surfactant content in the formulations is preferably from 5 to 25 wt. % (abrasives not included).

Stonewashing formulations may optionally contain further ingredients, e.g. enzyme activators, solubilisers, solvents, antioxidants, builders, or sequestrants.

Examples of typical solvents include ethylene glycol, propylene glycol and their oligomers/polymers, terpenes, hydrocarbons etc. Examples of enzyme activators include proteins, salts of monosaccharides, such as mannose and xylose. Typical solubilisers are short-chain alcohols, benzene sulfonate salts, propylene glycol, benzoates etc. Builders and sequestrants include organic phosphates, phosphonates, polyacrylic acids, polyvinyl alcohols, polyvinyl pyrrolidone, borates, citrates etc.

Both powdery formulations and liquid ones are suitable.

The process for producing denim fabric (jeans fabric) comprises three main steps: desizing, abrasion (stoning/biostoning), and bleaching.

Desizing (first step) means the removal of size, which is usually starch. In the past this was achieved by alkaline washing at higher temperatures. Today it is preferable to use an enzymatic method employing special amylases or a combination of amylases and lipases, which split the starch polymers into short, water-soluble fragments that can be washed out. It is thus possible to produce a soft denim surface, prevent striation, and prepare-the fabric for the next step, the abrasion. In this step, too, surfactants are employed besides enzymes.

Prior to the next treatment, one or several rinsing step(s) may be carried out.

Abrasion (second step) is achieved by stonewashing or biostoning or a combination of both. Special cellulases or cellulase mixtures are employed for removing cellulose fragments from the surface, thereby creating the classic stonewashed appearance.

Once the desired degree of abrasion is reached, the cellulases need to be deactivated in order to stop further fabric impairment. This is achieved by subsequent washing at alkaline pH values and higher temperatures, thereby denaturing the enzyme. The fabric then is bleached (third step) at standard conditions utilising the bleaching agents described in the art, e.g. hypochlorite.

The dye redeposition inhibitors described in the method of the invention are superior among others by showing affinity for hydrophobic surfaces, such as polyester, polyamide, and mixtures thereof with cotton. Since the accessories of jeans trousers, e.g. pocket inside lining, zippers, labels, seams etc., are usually made of these materials, it is recommendable to utilise the additives of the invention not only at the stonewashing stage but already earlier in the process, namely when desizing the fiber. The accessories thus receive an efficient surface impregnation to the principal effect of reducing redeposition of the indigo dye released during the stonewashing stage on these surfaces.

### EXAMPLES

### Example 1

Into a 2.0-liter multineck flask with glass stirrer, heating bath, inert-gas inlet, distillation head, packed column, distillation bridge, vacuum distributor, distillation flask, cooling trap, and internal thermometer there were placed under an inert-gas blanket 640 g (1.45 moles) of polyethylene glycol monomethyl ether having an average molecular weight of approx. 440 g/mole (MARLIPAL™ 1/12 from Sasol Germany GmbH), 388 g (2.0 moles) of dimethyl terephthalate, 110.5 g (1.2 moles) of glycerol, 145.8 g (1.4 moles) of neopentyl glycol, 1.0 g of 2,6-di-tert-butyl-p-cresol (Ionol™ from Shell), and 1 ml of tetraisopropyl orthotitanate.

The reaction mixture was slowly heated to temperatures from 150° C. to 220° C. and the methanol thus produced was collected. Once most of the methanol quantity theoretically expected was collected, the reaction mixture was cooled, the column was removed, vacuum was applied, and the mixture was reheated to not higher than 230° C. The unreacted diol-polyol blend was collected as a distillate.

Once the polyester reached a hydroxyl number of approx. 90 mg of KOH/g of substance, the reaction was discontinued. The resultant product was a low-viscous, yellow oil.

### Example 2

Example 1 was repeated using 883 g (2.0 moles) of polyethylene glycol monomethyl ether having an average molecular weight of approx. 440 g/mole (MARLIPAL™ 1/12 from Sasol Germany GmbH), 534 g (2.75 moles) of dimethyl terephthalate, 227.9 g (2.5 moles) of glycerol, 68.3 g (1.1 moles) of monoethylene glycol, 1.0 g of 2,6-di-tert-butyl-p-cresol (Ionol™ from Shell), and 1 ml of tetraisopropyl orthotitanate for the reaction.

Once the polyester reached a hydroxyl number of 112 mg of KOH/g of substance, the reaction was discontinued. The resultant product was a low-viscous, yellow oil.

### Example 3

Example 1 was repeated using 4,947 g (1.65 moles) of polyethylene glycol having an average molecular weight of approx. 3,000 g/mole (Lipoxol™ 3000 from Sasol Germany GmbH), 1,056 g (5.44 moles) of dimethyl terephthalate, 580 g (9.3 moles) of monoethylene glycol, 4.0 g of 2,6-di-tert-butyl-p-cresol (Ionol™ from Shell), and 4 ml of tetraisopropyl orthotitanate for the reaction.

Once the polyester reached a hydroxyl number of 30 mg of KOH/g of substance, the reaction was discontinued. The resultant product was a yellow solid resin.

### Example 4

Example 1 was repeated using 1,106 g (1.47 moles) of polyethylene glycol monomethyl ether having an average molecular weight of approx. 750 g/mole (NONIDAC™ M-750 from Sasol Italy), 229 g (1.18 moles) of dimethyl terephthalate, 179 g (2.36 moles) of 1,2-propylene glycol, 1.3 g of 2,6-di-tert-butyl-p-cresol (Ionol™ from Shell), and 1.3 ml of tetraisopropyl orthotitanate for the reaction.

Once the polyester reached a hydroxyl number of 15 mg of KOH/g of substance, the reaction was discontinued. The resultant product was a low-viscous, yellow oil.

1. A method of preventing or minimizing dye redeposition onto textile fabrics by contacting the dyed fabric comprising cotton fibers with is a dye redeposition inhibitor during the dye removal process, characterized in that the dye redeposition inhibitor is a polyester, which is produceable by reacting at least the following monomers:
(A) one or more dicarboxylic acid compound(s),
(B) one or more diol compound(s) having from 2 to 6 carbon atoms, and
(C) polyetherols with one or two hydroxy groups having at least 6 oxygen atoms, wherein the monomers (A), (B), and (C) result in more than 80 wt. % of the incorporated monomers.

2. The method according to claim 1, characterized in that the polyetherols (C) have average molecular weights from 500 to 10,000 g/mole, especially from 1,000 to 8,000 g/mole.

3. A method according to any one of the preceding claims, characterized in that the polyesters is furthermore produceable by using
(D) one or more polyol compound(s) with at least 3 OH groups having from 3 to 12 carbon atoms, especially glycerol.

4. The method according to claim 1, characterized in that the polyesters is produceable by reacting at least
(A) 20 to 50 mole % of one or more dicarboxylic acid compound(s),
(B) more than 0 to 30 mole % of one or more diol compound(s) having from 2 to 6 carbon atoms,
(C) 10.1 to 50 mole % of one or more water-dilutable polyetherol(s), which can be produced by the addition of one or more C₂- to C₄-alkylene oxide(s) to a C₁ to C₁₈ alcohol, especially a C₁ to C₆ alcohol, with one hydroxy group, wherein the alkylene oxide/alcohol mole ratio is in the range from 4 to 100:1, and
(D) 10.1 to 29.9 mole % of one or more polyol compound(s) having at least 3 OH groups.

5. The method according to claim 4, characterized in that 1 to 10 mole % of the diol compound (B) is incorporated.

6. A method according to any one of claims 4 or 5, characterized in that the average molecular weight of the polyester is less 5,000 g/mole, preferably from 2,000 to 5,000 g/mole.

7. A method according to any one of the preceding claims, characterized in that the dicarboxylic acid compounds (A) comprise terephthalic acid, isophthalic acid, and phthalic acid and their derivatives, especially terephthalic acid and its derivatives, preferably in a quantity of greater 90 mole % of terephthalic acid and its derivatives, based on the incorporated dicarboxylic acid compounds.

8. A method according to any one of the preceding claims, characterized in that independently of one another
(a) no tricarboxylic acid compounds and
(b) less than 10 wt. % of isophthalic acid or its derivatives, and especially no isophthalic acid or its derivatives are employed.

9. A method according to any one of the preceding claims, characterized in that the diol compound (B) is ethylene glycol and/or propylene glycol.

10. A method according to any one of the preceding claims, characterized in that the polyester is anionically modified by incorporation of anionic monomers and/or is capped with terminal groups.

11. A method according to any one of the preceding claims, characterized in that the polyester is produceable by reacting at least
(A) terephthalic acid, wherein the terephthalic acid comes to more than 90 mole % of the dicarboxylic acid compounds employed,
(B) ethylene glycol, wherein the ethylene glycol comes to more than 90 mole % of the diol compounds employed, and
(C) polyethylene glycol having a molecular weight from 2,000 to 8,000 g/mole, wherein polyethylene glycol having a molecular weight from 2,000 to 8,000 g/mole comes to more than 90 wt. % of the polyetherols employed.

12. A method according to any one of the preceding claims, characterized in that the polyetherols (C) are alkylene oxide addition products of ethylene oxide, propylene oxide, butylene oxide or their mixtures to aliphatic C₁ to C₁₈ alcohols, preferably C₁ to C₆ alcohols, and/or water to water or methanol.

13. The method according to claim 1, characterized in that the polyesters are composed according to the formula
X—(OCH₂—CH₂)ₙ—[—(OOC—R¹—COO—R²)ᵤ—]—OOC—R¹—COO—(CH₂—CH₂O)ₙ—X,
wherein each R¹ residue is a 1,4-phenylene residue, optionally substituted for mono- or di-C₁-C₃-alkyl; the R² residues are principally ethylene residues, 1,2-propylene residues, or mixtures thereof; each X represents independently of one another hydrogen, a C₁ to C₁₂ hydrocarbon residue, especially ethyl or methyl; each n is a number from 7 to 115, and u is a number from 3 to 10.

14. A method according to any one of claims 5 to 13, characterized in that the polyester or polyester blend is liquid at room temperature.

15. The method according to claim 1, characterized in that the average polyesters are composed according to the empirical formula
(CAP)ₓ(T)_{z}(I)_{q}(D)ᵣ(P)ₛ(En)ₜ(A)_{y}(EG/PG)ᵥ,
wherein
(CAP) represents terminal groups capping the polymer at its end and
a) sulfoaroyl groups,
b) groups of the formula MO₃—S—(O)ᵤ—(CH₂)ₚ—(RO)_{w}—,
wherein M represents a metal ion, ammonium ion, or substituted ammonium ion, R means ethylene or mixtures of ethylene and propylene, u is 0 or 1, p is 0 or 1, and w represents an integer from 1 to 100,
c) poly(oxyethylene)monoalkyl ether groups, wherein the alkyl group has from 1 to 24 carbon atoms and the polyoxyethylene group is comprised of 2 to 200 oxyethylene units,
d) acyl- and aroyl groups having from 4 to 40 carbon atoms,
e) hydroxyacyl- and hydroxyaroyl groups having from 2 to 25 carbon atoms,
f) poly(oxyalkylene)monoalkyl phenol ether, wherein the alkyl group has from 6 to 18 carbon atoms and the polyoxyalkylene group is comprised of 0 to 80 oxyalkylene units
g) and mixtures thereof, and x represents a number from 0 to 2,
(T) is an arylene dicarbonyl group and z represents a number from 1 to 50,
(I) is an internal anionic group and q represents a number from 0 to 30,
(D) is an acetal group and r represents a number from greater 0 to 80,
(P) means polyol groups having at least 3 —OH groups, s is a number from 0 to 80, wherein the polyol quantity is less than 30 mole %, related to the total monomer units,
(En) is a poly(oxyalkylene)oxy group composed of 2 to 100 oxyalkylene groups, wherein t is a number from 0 to 25, and the alkylene groups have from 2 to 6 carbon atoms,
(A) is a 1,n-alkylene dicarbonyl group composed of 2 to 24 carbon atoms, and y represents a number from 0 to 15,
(EG/PG) is an oxyethylene oxy- or oxypropylene oxy group or mixtures thereof, and v represents a number from 0 to 80, and
wherein the polyesters have molecular weights from 500 to 100,000 g/mole, preferably from 1,000 to 20,000 g/mole.

16. The method according to claim 15, characterized in that (I) represents the sodium salt of the 5-sulfoisophthaloyl group.

17. A method according to any one of claims 15 or 16, characterized in that (CAP) represents the sodium salt of the 5-sulfoisophthaloyl group.

18. A method according to any one of claims 15 to 17, characterized in that the acetal group (D) is independently of one another:
the reaction product of a formyl ester with glycerol,
the reaction product of a dialdehyde with 2 moles of glycerol, and/or
the reaction product of a tetraalkoxy propane with 2 moles of glycerol.

19. A method according to any one of claims 15 to 18, characterized in that q, x, and y are 0.

20. A method according to any one of the preceding claims, characterized in that for the removal of dye abrasive stones and/or enzymes, especially at least cellulases, are put into contact with the fabric in order to achieve a stonewashed look.

21. A method according to any one of the preceding claims, characterized in that the dye redeposition inhibitor is put into contact with the fabric both during the stonewashing step and the preceding desizing step.

22. A method according to any one of the preceding claims, characterized in that the dye part of which needs to be removed is indigo.

23. A method according to any one of the preceding claims, characterized in that the polyetherols (C) have from 16 to 180 C₂ to C₄ alkylene oxide units.

24. A method according to any one of claims 1, 2, and/or 5 to 23, characterized in that the polyester is not made utilizing polyols having at least 3 OH groups.

25. A method according to any one of the preceding claims, characterized in that the polyesters have molecular weights of less than 5,000 g/mole.

26. Use of the polyester defined by any one of claims 1 to 19, 23, 24, and/or 25 for preventing or minimizing dye redeposition onto textile fabric during stonewashing or biostoning of indigo-dyed cotton fabrics.

27. Indigo-dyed cotton fabric, characterized in that the indigo-dyed cotton fabric is produced in the presence of a polyester during a stonewashing or biostoning process in order to prevent dye redeposition and the polyester is defined by any one of claims 1 to 19, 23, 24, and/or 25.
